(19) United States
(12) Patent Application Publication
(10) Pub. No.: US 2007/0126196 A1
(43) Pub. Date: Jun. 7, 2007

(54) Third axle assembly for log hauling trailers

(76) Inventor: Kenneth Fritz Klahn, Forks, WA (US)

Correspondence Address: JACQUES M. DULIN, ESQ. DBA;INNOVATION LAW GROUP, LTD., 237 NORTH SEQUIM AVENUE, SEQUIM, WA, 98382-3456, US

(21) Appl. No.: 11/425,193

(22) Filed: Jun. 20, 2006

Related U.S. Application Data
(60) Provisional application No. 60/695,791, filed on Jun. 29, 2005.

(51) Int. Cl. B62D 61/12; B62D 53/00

(52) U.S. Cl. 280/86.5; 280/404

(57) ABSTRACT

Improved third, tag, axle for a standard two-axle log-carrying trailer to permit carrying additional load. The inventive third axle assembly is pivotally linked directly to the bunk of a standard log trailer bogie by two, laterally-spaced hitch assemblies that permit vertical motion of the third axle, but not lateral movement. The inventive third axle assembly increases the payload capacity of the trailer with better maneuverability. A pivoting cone support and centering assembly is used to insure proper alignment of the tag axle during transport and when first unloaded. By following the bunk, the inventive axle more closely follows the tractor front wheel path during turns, rather than worsening the cut-across effect of ordinary turn geometry. That is, the inventive tag axle tracks more nearly in the proper lane, tending significantly less to cut across inside the tractor turn in both left and right turns, and thus is a safer rig.

### CROSS REFERENCE TO RELATED APPLICATIONS

This is the Regular US patent application of prior Provisional Application Ser. No. 60/695,791 filed Jun. 29, 2005 by the same inventor under the same title, the priority of which is claimed under 35 US Code, Sections 119, 120, ff, and the disclosure of which is hereby incorporated by reference.

### FIELD

The invention pertains to over-the-road truck-trailer rigs for hauling logs, poles, beams and other items lengthy relative to their girth, herein called “logs”, whether of wood, concrete, steel or any other material; and pertains more particularly to a novel tag axle trailer assembly useful for increasing the load capacity of log hauling trailers by addition of an auxiliary (third) axle to the trailer without compromising maneuverability.

### BACKGROUND

Design factors for over the road log hauling rigs comprising a truck and trailer include, among others things, the economics of maximizing the payload capacity per trip, and the limitations imposed by roadway configuration with respect to maneuverability of the rig especially in turns and in backing.

Payload capacity per trip is typically limited by regulations governing maximum gross weight as a function of both axle and tire factors, including weight per inch of tire width and numbers of tires per axle. In addition, permitted payload is a function of wheelbase and axle factors including numbers of axles and grouping of axles. For example, the State of Washington, in a relatively complex set of regulations, specifies weights of 500 to 600 pounds per inch of tire width with variations according to the number of tires per axle and other factors. The result is gross load on a single axle is limited to 20,000 pounds. That rule is modified by other rules that specify (in tabular form) maximum load restrictions for groups of two to nine consecutive axles with spacing between the extremes of any group from 4 feet to 86 or more feet. The maximum weight currently permitted is 105,000 pounds. Generally, where load carrying capacity is the only concern, the more axles the better.

These weight rules have general applicability to all vehicles on the public road, including moving vans, general freight haulers, and log hauling rigs. Thus, design of equipment for maximum economic return per load entails a detailed consideration of the running gear (wheel and axle assembly) design.

For log hauling, it is highly desirable to distribute the weight over many axles. A large number of currently used log hauling rigs consist of a 5-axle tractor-trailer truck, comprising a powered tractor unit having two front wheels, eight back wheels on two axles, plus a trailer having eight wheels on two axles. Such a standard 5-axle log-hauling truck-trailer rig carries a payload of about 54,000 pounds. The addition of a third axle to the trailer unit can increase the payload weight by about 6000 to 8000 pounds, i.e. some 12% to 15%. Note: The term “truck” has two meanings: 1) The entire vehicle comprising the tractor with the trailer; and 2) the tractor only. As used herein, “truck” commonly refers to the tractor, and the entire vehicle will be called truck-trailer, or tractor-trailer or semi-trailer, as context dictates.

Next, roadway configuration imposes significant maneuverability requirements on public road users. For example, drivers must be able safely to negotiate corners and turns. A common occurrence of poor control is a stretch limousine, bus, long haul semi-trailer or a moving van wiping out the street light on the corner while negotiating a right angle turn on city streets. That's an example of the running gear causing the trailer to “cut across the corner.” To avoid cutting across the corner, the driver must swing wide before beginning the turn. The converse problem is that the rear end of the trailer swings into oncoming traffic lanes when the semi-trailer makes a left turn. For that reason, such long vehicles carry a “wide turn” warning placard on the back of the trailer. In addition, log-hauling rigs must be capable of being driven into forests or log yards to load the logs. This requires a capability for maneuvering on logging roads which do not necessarily meet the standards of public roads.

Loaded log hauling rigs are so long that the corner cutting and swing wide problem can be worsened by the addition of an axle or axles, to increase payload. An instructive web site is www.fleetwatch.co.za/tw2004/info/p148.jpg. It addresses “Turning Ability of Vehicles” in the context of a six-axle 10 meter semi-trailer showing a 13.7 meter outer turn radius (the outside front corner of the cab) and a 4 meter inner turn radius at the inner hub of the center trailer axle. That is, the difference in turning radius, 9.7 meters, means that the corner is cut or the tail swings wide by 30′. Thus, the semi tractor-trailer requires a road width of 30′ to be able to turn. Many roads are no more than 30′ wide, hence the semi takes up the entire roadway in a turn, posing a danger to vehicles in oncoming lanes and roadside objects (parked vehicles, light and telephone poles, etc.). While that “fleet watch” site gives formulas for turning radius computations for semis, those are not directly applicable to log hauling truck and trailer rigs, because log trailers are “stinger steered,” not merely pulled along behind the truck as is a semi trailer.

Design of log hauling trailers differs radically from the ordinary semi-type freight hauling trailers, either enclosed or flat bed. Semis have a frame, the forward end of which rides on the back of the truck (on the so-called 5^{th} wheel pan support). The back of a semi-trailer frame is supported by trailer wheels and a suspension assembly. In contrast, log hauling trailers use the log load itself for the “trailer” frame. The forward end of the logs rest in a U-shaped fork assembly, called a “bunk,” carried above the tractor axles. The U-shaped bunk fork permits logs to be stacked and secured in it by chains or cables. There is a similar bunk above the rear trailer axles. The bottom of each bunk rests in a “cup and saucer” assembly that permits the bunk to pivot. In turn, the cup and saucer assembly rests on the “bogie” unit which is a framework to which wheels, axles, and suspension are mounted.

A “stinger” extends beyond the rearmost point of the tractor frame, and well behind its rear axle. It is the connection point for the rear trailer bogie via a telescoping boom, called a “reach.” The stinger and reach are connected by a pivoting hitch mechanism. (The forward end of the stinger is also pivotable about a horizontal axis at its connection point to the tractor; this pivot permits stowing the rear bogie on the tractor frame during empty transport.)

The purpose of the stinger is to steer the trailer, not to pull it. The further the stinger connection to the reach is located behind the rear truck axle, the greater the steering effect on the trailer bogie and the less the difference between the outer turning radius and the inner turning radius of the tractor and trailer. If the distance of the stinger/reach from the tractor's rear axle equals the distance from the stinger to the trailer bogie “mean axle,” the trailer wheels would exactly track the truck wheels. By “mean axle” is meant the mid-point between the bogie axles. But in practice such equality is not achievable. In addition, the reach telescopes during travel, particularly turning. It also telescopes to permit carrying logs of different lengths. In any event, the difference between inner and outer turning radii for a logging truck, tractor and trailer, tends to be less than that for a comparable length semi-trailer. Thus, while log truck cornering problems seem eased to some extent, that is offset by the fact that logging trucks are usually substantially longer than semi-trailers.

The increase in permissible payload for logging rigs by the addition of a third axle to the trailer is sufficient motivation to do so, provided it can be done economically and without compromising maneuverability. Since adding a 3^{rd} axle changes the mean axle position of the trailer bogie, the turning radius is adversely affected.

The prior art includes several patented designs that attempt to increase log hauling payload. Exemplary designs include the following, all of which are readily distinguishable from the present invention:

U.S. Pat. No. 6,050,578 of Beck discloses a load booster comprising an axle assembly that attaches to the lateral center point of the bunk of the log trailer via a ball joint. The ball joint permits the 3^{rd} axle to swing both laterally and vertically while being towed. Ths ball joint is in effect another stinger and results in separate maneuverability factors for the 3^{rd} booster axle.

U.S. Pat. No. 5,110,149 of Dahlstrom discloses an auxiliary 3^{rd} tag axle that is pivotally fastened to the main trailer chassis and is able to assume an adjustable portion of the payload weight.

U.S. Pat. No. 5,163,698 of Evans discloses mounting the rear bunk on a load transfer beam between the main trailer and the 3^{rd} tag axle, rather than the bunk being at its standard location, mounted to the trailer bogie frame. This changes the pivot points and distances from stringer to mean axle as compared to bund-to-bunk distances, lengthening the latter, thus changing turning geometry. It is also a very expensive, non-retrofit solution to increasing load capacity.

U.S. Pat. No. 4,219,210 of Genberg discloses an auxiliary trailer which carries the rear log carrying bunk that has been removed from the main trailer and reinstalled on the auxiliary trailer. The auxiliary trailer attaches to the main trailer using the cup and saucer that originally carried the relocated bunk of the main trailer or some equivalent coupling at the same position.

Each of the foregoing patents embody approaches and concepts resulting in different trade-offs between payload economics, trailer maneuverability and ease and cost of retrofitting on existing trailer bunks/bogie units. Thus there remains an unmet need for a simple, inexpensive, retrofit system for adding a 3^{rd}, tag axle unit to a trailer bogie that permits increasing the payload of logging truck and trailer rigs while maintaining maximum maneuverability. The present invention contributes such a solution.

### THE INVENTION

### Summary, Including Objects and Advantages

The present invention is directed to the addition of a third axle, called a tag axle, to a standard two axle rear bogie of a log carrying trailer to permit carrying an additional load of logs. In a presently preferred embodiment, the inventive third axle assembly is linked directly to the bunk of a standard log trailer rear bogie by two, laterally-spaced hitch assemblies that permit vertical motion of the third axle assembly, but not lateral movement. Other than travel support and alignment comes described in more detail below, no other modifications to the trailer bogies are required. The inventive auxiliary third axle assembly achieves the goal of increasing the payload capacity of the trailer, while providing maneuverability far superior to currently-available third axle systems.

The inventive third axle assembly comprises an elongated Z-shaped (as seen in side elevation) parallel beam frame, of standard 34″ trailer frame width, to which is mounted a commercially available steerable, reverse caster air suspension axle and wheel assembly. The novel system of attachment of the inventive third axle assembly directly to the bunk or the rear trailer bogie, rather than to the bogie frame, employs a laterally spaced pair of “hinge-type” fittings or “ears” connecting the forward ends of the right and left side frame members of the inventive axle assembly to the trailer's bunk. A first embodiment of each connector fitting includes a vertical tongue, flange or ear secured to the trailer bunk by bolting or welding. Yokes are mounted on and project from the forward ends of the right and left frame members of the third axle assembly. Each yoke and flange are connected by a horizontal hinge pin that passes through aligned holes in the yoke arms and the flange. The hinge pin may be a large rod having a head at one end and a cross-drilled hole through which is passed a large cotter pin at the other. More preferably, the hinge pin is a single bolt/nut at each connection point.

The preferred connection is to employ the yoke welded to the bunk, with each forward end of the frame members terminating in a tongue or flange plate that is received between the arms of the yoke. The holes in yoke and flange plate align and receive the hinge pin or bolt.

The pair of spaced connections provide for vertical pivoting of the third axle assembly but lateral tracking of the third axle to the bunk, the third axle pivoting during turns independent of the rear bogie. The inventive tag axle assembly follows the bunk, not the rear bogie, and this tracks closer to the path of the front axles, both the tractor and the front bunk paths. That is, the third axle can pivot up and down to follow roadway contours, and the frame may be raised or lowered to contact or be free of the load by means of air bellows but the inventive third axle has minimal to no lateral movement or sway.

A spaced pair of cones is mounted via a pivoting plate on the rear bogie frame for engaging corresponding conical receivers on the underside of the inventive tag axle frame members. These cones serve two functions in the upright position: First, when the rear bogie is loaded onto the front bogie (the stinger folds in 2 places) the cones support the tag axle with the wheels off the ground. Second, in the process of unloading, the cones prevent the tag axle from being mis-aligned. Once the tag axle is on the ground, the bellows are inflated to raise the tag axle frame and the cones are rotated down. This permits the tag axle to move vertically with the road surface. It is advisable to raise the axle and lower the cones once the bogie and tag axle are on the ground rather than waiting until fully loaded. It is possible to raise the axle with a partial load, but the trailer should not be loaded so much that the bellows are not be able to raise the frame sufficiently to permit the cones to clear the receivers.

This system of attachment directly to the trailer bunk causes the third axle wheels to track directly in line with the logs during turns, rather than tracking the trailer rear bogie wheels, but further behind. As truck drivers, farmers and anyone towing a trailer, the tractor (the towing vehicle), must make wide turns in order that the trailer does not cut excessively across the turn, wiping out mailboxes, light posts, fence posts, building corners, bridge abutments, or leaving swaths of uncut hay or grass, or gaps in the plowing, and the like. The longer the towed load, the more the “cut-across” the arc of the turn. That is, the load tends to follow a chord within the arc of the tractor front wheels, and the longer the load, the greater the chord. Current tag axles effectively move the rear bogie back by 6-8′, increasing the cut-across effect. In contrast to conventional tag axles that are attached to the rear bogie or trailer frame, the inventive auxiliary tag axle tracks the trailer bunk, not the bogie frame. Since the rear bunk tracks the front bunk, and the inventive tag axle tracks both, the result is that the inventive tag axle tracks independent of the rear bogie, so that the addition of the third axle does not substantially lengthen the load chord and increase the cut-across effect. Stated another way, the inventive tag axle does not function to move the rear bogie back, and thus does not exacerbate the trailer bogie cutting inside the tractor wheels track.

In addition, employing a steerable wheel assembly in the inventive tag axle permits it to track very closely the path of the front wheels.

Other preferred but optional features of the inventive third axle assembly include: a load weight bearing beam to support logs when loaded; a pneumatic load lift system; reverse and adjustable caster; air suspension axle; and a cone and receiver system for the third axle assembly's frame to rest on the rear of the trailer when dead-heading unloaded and for proper alignment at the commencement of loading.

### BRIEF DESCRIPTION OF THE DRAWINGS

The invention is described in more detail with reference to the drawings, in which:

FIG. 1 shows in side elevation a typical logging truck and dual bogie trailer loaded with logs via the included boom, to which the inventive tag axle assembly has been hitched and the air bellows inflated to shift a portion of the log weight to the third axle;

FIGS. 2A-2C are a series of side elevation views of the procedure for readying the log truck of FIG. 1 for loading by unloading the rear bogie and tag axle from the stowed, road travel position, in which:

FIG. 2A is a side elevation view of the logging truck of FIG. 1 in which the operator is using the boom grapple to lift the rear bogie off its road travel support bars, the inventive tag axle being supported with wheels off the ground by the cone assembly;

FIG. 2B shows the inventive tag axle touching ground and the stinger unfolding; and

FIG. 2C shows the rear bogie unloaded, the reach extended and the cones still raised, just before lowering them in order to place the tag axle in the ready-to-load mode;

FIG. 3 is a rear elevation of the inventive third, tag axle assembly showing the log load beam and the air lift bellows;

FIG. 4 is a rear isometric view of the inventive tag axle assembly showing how it is hooked to the rear bogie bunk;

FIGS. 5A-C are a series of partial side elevations/partial sections showing the cone support and centering assembly, in which:

FIG. 5A shows the support of the inventive tag axle frame assembly during road travel, that is, the orientation corresponding to FIG. 2A;

FIG. 5B shows the cones supporting the inventive tag axle frame assembly in the position ready to load logs, that is, the orientation corresponding to FIG. 2C; and

FIG. 5C shows the cones rotated down out of the centering receivers when the logs are loaded, that is, the orientation corresponding to FIG. 1;

FIG. 6 is a side elevation of a second embodiment of the inventive tag axle having a straight frame, showing it in use supporting a load of logs when the bellows are inflated to take log load; and

FIG. 7 is a schematic top plan view showing relative paths of travel of the tractor front wheels, the front bogie, the rear bogie, the inventive tag axle in comparison to a prior art tag axle, thus illustrating the reduction in the cut-across effect.

### DETAILED DESCRIPTION INCLUDING THE BEST MODES OF CARRYING OUT THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. For example, the various electrical and pneumatic connections to lights, brakes and lift bellows, being conventional to those skilled in this art, are not shown. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

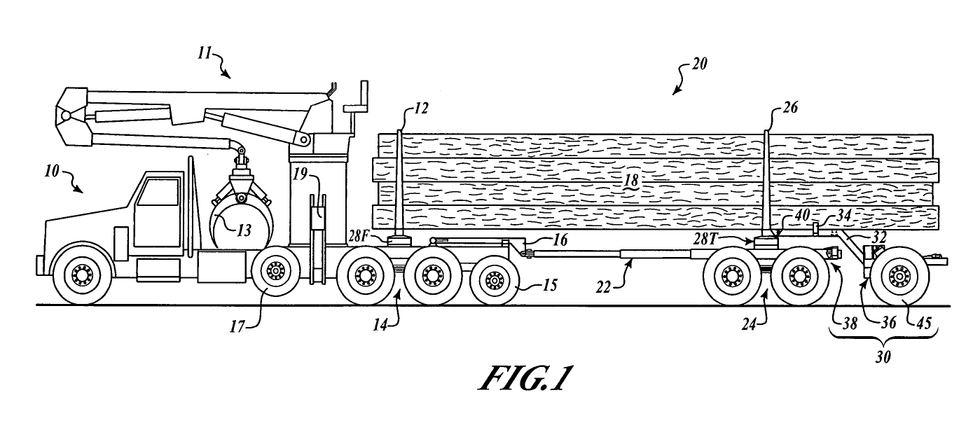

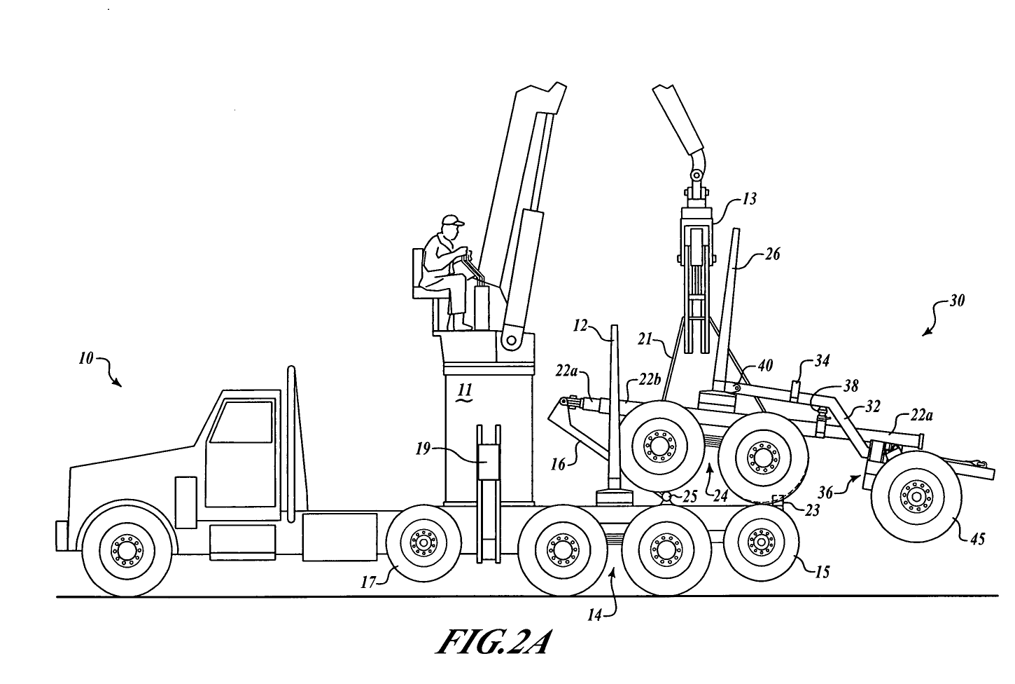

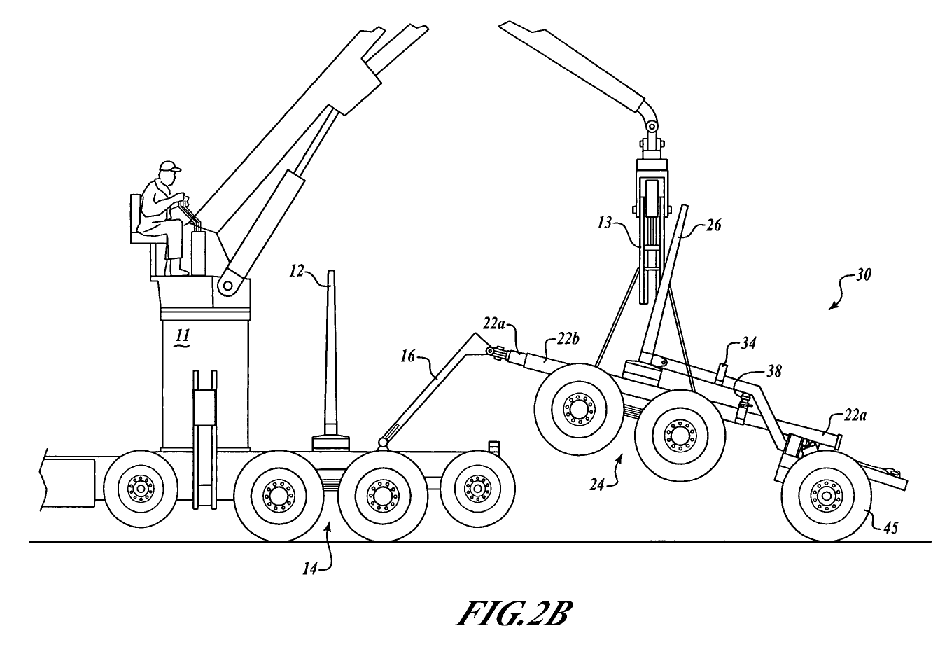

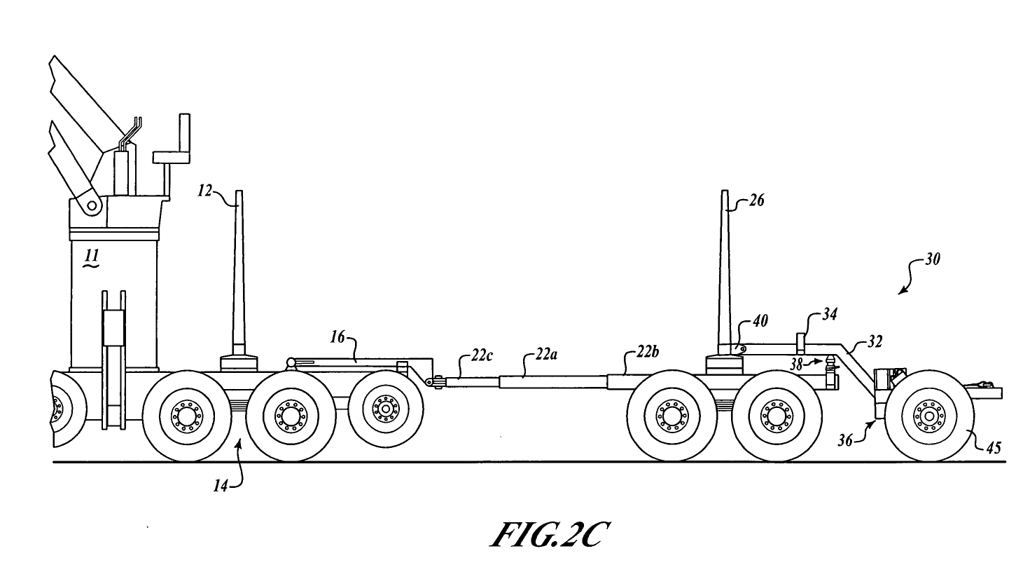

FIG. 1 shows in an operation context the inventive tag axle assembly 30 attached to the rear bunk 26 of a standard logging truck rig comprising tractor 10 and a standard two axle logging trailer 20. The present invention makes no modification to either the truck or the trailer, other than the addition of the attachment hitch yoke points 40 on the rear bunk 26 and travel support cone 38 fittings for the inventive third axle assembly 30. The hitch yokes 40 connect the tag axle assembly 30 at the forward end of its frame 32, and the support cones engage receivers on the frame, as described in more detail in connection with FIGS. 2A-C and 5A-C.

The payload of logs 18 rests at its forward end on the forward bunk 12 mounted on the truck, and at the rear end on the trailer's bunk 26. Each of the bunks is mounted in a “cup and saucer” assembly 28F, 28T, that permit the bunks to swivel in tandem freely and independently of the bogies 14, 24 when logs are loaded. Each cup and saucer in turn is supported by the respective truck and trailer bogies 14, 24. The bogies are the respective suspension systems of the truck and trailer, and the attachment points for the axles. The log payload 18 serves to connect the truck and trailer and applies the turning force from the truck to the trailer. In addition, the trailer's telescoping reach 22 connects the trailer to the truck at the connection with the stinger 16, more as a steering connection rather than the towing force conveying link. The location for attaching the inventive third axle assembly (seen in FIGS. 1, 2C and 4) to the trailer bunk 24 is shown at 40.

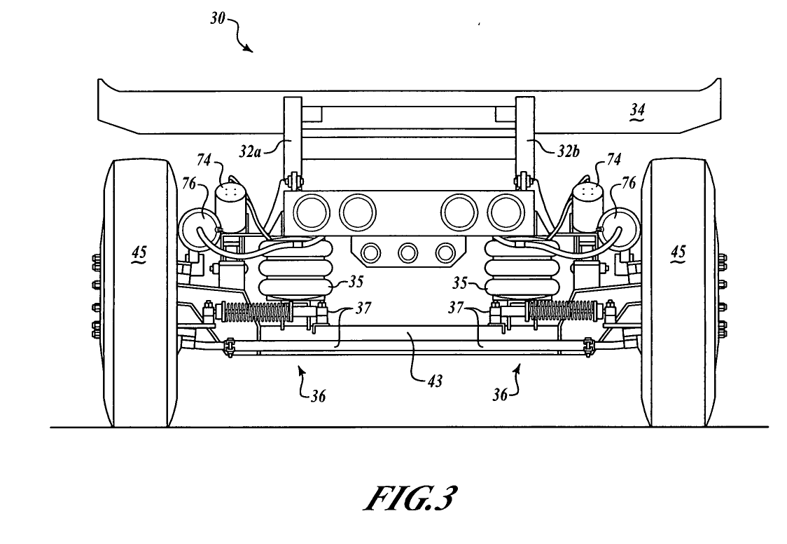

In this view the steerable reverse caster air suspension assembly 36 is inflated causing the real of the third axle assembly frame 32 to rise, pivoting at its forward end (at the hitch 40), com-pare FIGS. 2C and 3. The transverse load-bearing beam 34 is attached to the top of the frame 32 and rises as the frame rises, causing the beam to come into contact with the logs and to transfer a portion of the log load weight from the bunk to the load bearing beam, and thence to the third axle assembly 30. The amount of the weight transferred is determined by the pressure to which the air suspension is inflated.

In some truck types, the truck includes a crane 11 having a grapple 13 for loading and unloading both the rear bogie/bunk assembly (see FIGS. 2A-C) and the logs comprising the log load. Note that the front bogie includes a drop-down auxiliary axle 15 to assist in carrying the log load. In addition, as needed, particularly when using the crane, a second drop-down axle assembly 17 is used to carry load. For stabilization, crane legs with foot-pads 19 are deployed when loading logs.

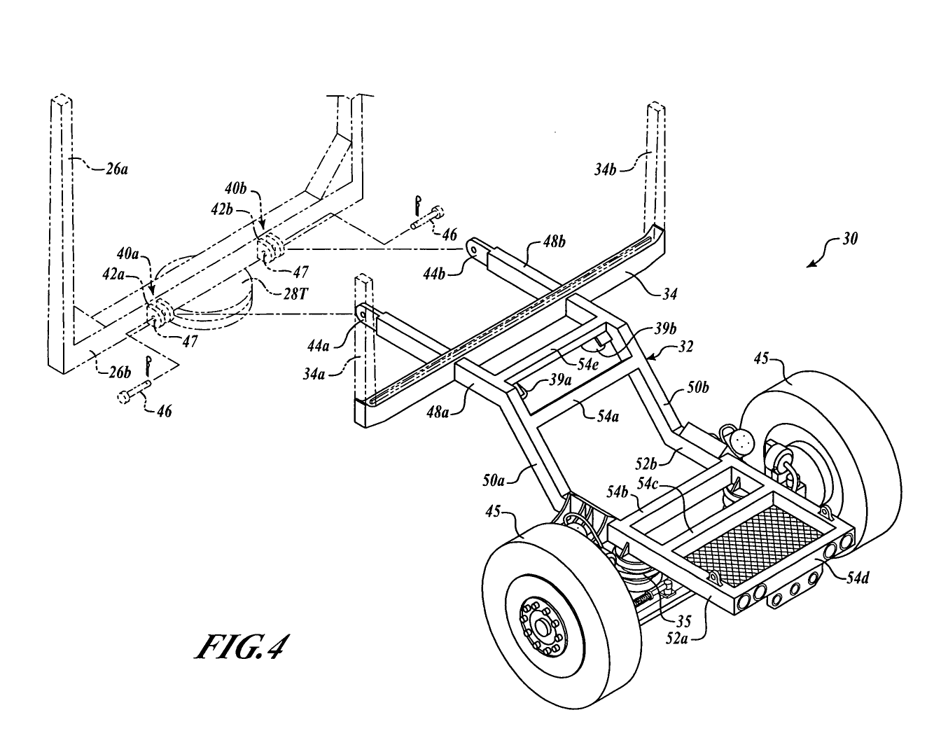

FIGS. 2A-2C show the steps for unloading of the rear bogie 24 having the inventive tag axle assembly 30 hitched to it. In FIG. 2A the driver operates the crane 11, using the grapple 13 to engage lift cable 21 attached to the rear bogie 24. The tag axle assembly 30 is hitched at 40 to the rear bunk 26, and the tag axle frame 32 is supported by the cone and receiver assemblies 38. Note the rear bogie rests on transverse rest bracket 23 during transport. Note also that the trailer reach 22 is connected to the stinger 16 which is pivoted forward at hinge 25. In this position the reach is telescoped so that the inner tube 22a slides back through the outer sleeve 22b in the process of lifting and folding the stinger and reach, and the rear end of the inner tube 22a can be seen extending to the right and above the tag axle wheel 45. Since the crane is lifting along the fore/aft axis of the truck, and no additional load is involved, neither the auxiliary drop wheels 15, 17 or the legs 19 need be deployed. The tag axle attachment hitch assemblies 40 (better seen in detail in FIG. 4) are spaced apart and located at the left and right sides of the rear vertical face of the trailer bunk 26, and connect the bunk to the forward end of the third axle assembly frame 32.

In FIG. 2B the operator has lowered the rear bogie and attached tag axle assemblies 24/30 so that the rear wheel 45 of the tag axle just touches the ground. Note the stinger unfolding and the reach 22 beginning to extend. In FIG. 2C the rear bogie 24 is now fully on the ground, the crane 11 stowed, the stinger 16 is in its lowered, operational position, and the reach 22a, 22b, 22c fully extended. The cone/receiver assembly 38 is still raised, and the cones will now be rotated down, typically no later than by the time a partial load of logs has been placed in the bunks. The cones properly align the wheels of the tag axle assembly 30 with respect to the truck and trailer during unloading.

FIG. 3 shows a rear view of the inventive third, tag axle assembly 30 comprising the spaced, parallel frame members 32 connected to the axle 43 and wheels 45, which are steered through steering linkage 37. The steerable reverse caster air suspension assembly includes the lift bellows 35 for raising and lowering the load-bearing beam 34 into contact with the log load and permitting the cone assembly 38 (not visible in this view) to be rotated down or up as the need dictates. Steerability is achieved through bi-acting pneumatic caster cylinder 74 that changes caster to reverse caster angle when the truck is placed in reverse. Air brake cylinder 76 is also shown.

FIG. 4 shows an isometric view of the rear of the log trailer 20 having the frame 32 of the inventive third axle assembly 30 attached at spaced hitch points 40a, 40b on the lower cross segment 26b of the bunk which pivots on the cup and saucer assembly 28T. The bunk uprights are labeled 26a, 26b. Note the hitch assemblies 40a, 40b are located above the wheels of the trailer bogie so that the tag axle frame members 32 do not drag on the tires and interfere with turning. The hitch points 40a, 40b are located spaced apart the same width as the forward ends of the third axle assembly left and right forward frame members 48a, 48b. The location of the two air bag components 35 of the air suspension assembly 36 is shown beneath the rear frame members 52a, 52b. Their inflation lifts the rear end of the frame members providing a leveraged lift to the transverse load-bearing beam 34, the forward ends of the frame 32 being pivotably secured between the yokes 40a, 40b via the vertically oriented tongues or connector plates 44a, 44b by bolts 46 or pins secured by nuts or cotter pins through the aligned holes 47a, 47b in both the yokes and the tongues. In this embodiment, the tongue is an elongated D-shaped plate welded into a slot in the forward end of the heavy tubing comprising the forward frame elements 48a, 48b. The yokes are spaced D-shaped plates welded to the bunk cross member 26b, as shown.

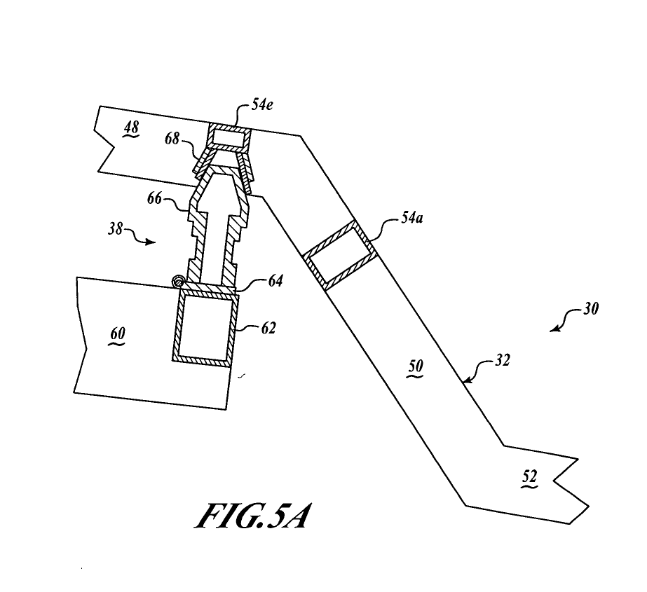

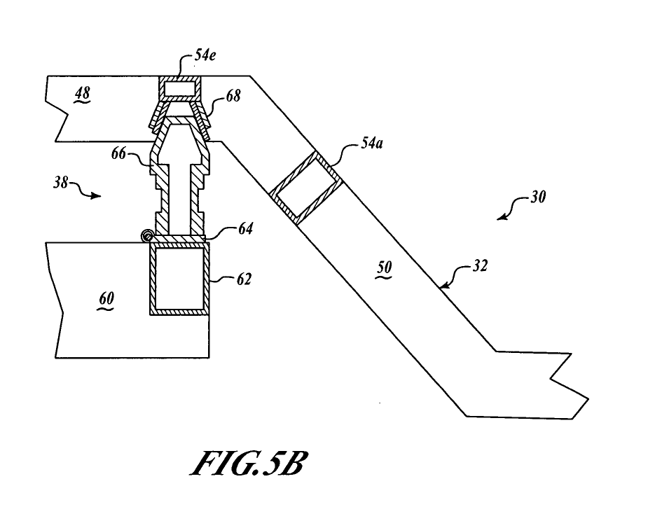

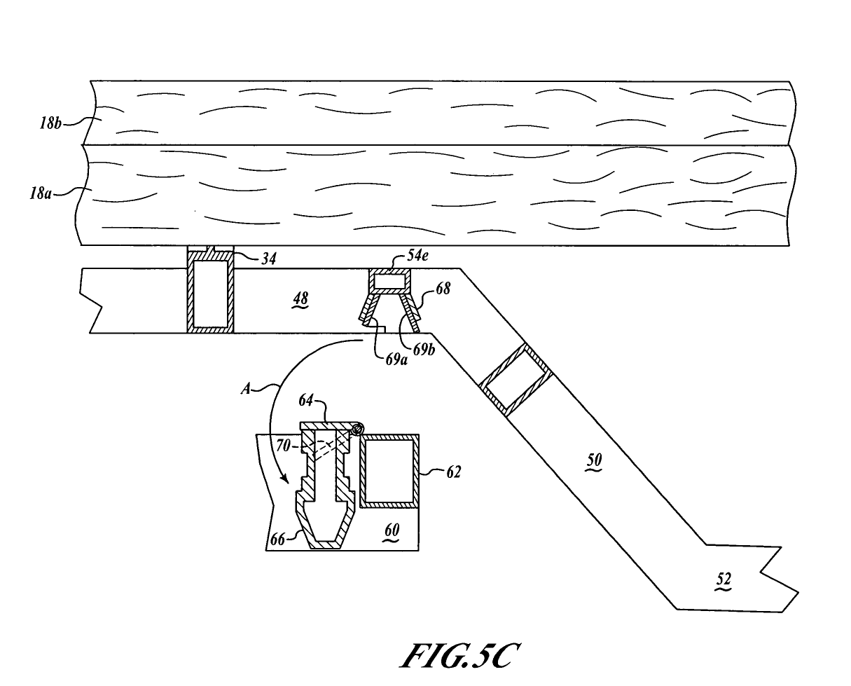

Note that the frame 32 includes a forward generally horizontal section 48, an angled off-set mid-section 50 and a rearward generally horizontal axle mount section 52. The two side rails 32a, 32b, are maintained in alignment by cross braces 54a, 54b, 54c, 54d, 54e and the load bearing beam 34, the top of which optionally but preferably includes a vertically oriented rib, which may be serrated, to assist in engaging the underside of the logs. The cross-brace 54b is above and linked to the axle and suspension (springs or/and steerable reverse caster air suspension) assembly of the inventive third, tag axle. The receivers 39a, 39b are mounted on the underside of the cross-brace 54e. Their function is described in detail below in connection with FIGS. 5A-5C.

Additional cross braces, such as 54c, 54d may be provided as needed, and mud flaps (not shown), road running and stop lights, reflectors and lifting eyes may be provided on the frame as required (shown but not numbered in FIG. 4). In the embodiment shown, typically two pairs of mud flaps will be installed on spring-retained removable outriggers, one pair forward of the tag axle wheel 45 to dampen spray from the rear bogie wheels, and one rearwardly of the tag axle wheel to dampen spray from it.

In an alternate embodiment of the load beam 34, it may include risers 34a, 34b, such as the half to ⅓ height risers shown in phantom in FIG. 4. The risers can include vertically slidable extension members to increase the height as needed. In an alternate embodiment of the yoke and tongue attachment of the tag axle frame to the rear bogie bunk, the parts can be reversed. That is, the attachment yokes 42a, 42b comprises a pair of D-shaped plates welded to each side of the heavy tubing comprising the forward frame element members 48a, 48b, and the tongue is an elongated D-shaped plate welded to the bunk cross member 26b. The steel plate elements forming the yoke and tongue elements 42a, 42b and 44a, 44b, respectively, are typically 2″×6″ plate, each of which includes an aligned hole 47 through which a bolt, linch-pin or stud 46a, 46b is passed. Thus, when the bunk yokes and the frame tongues are aligned and the pin fitted, a hinge is formed providing for vertical pivoting only of the frame with respect to the bunk. Other vertical hinge hitch embodiments can readily be used that provide the required functionality.

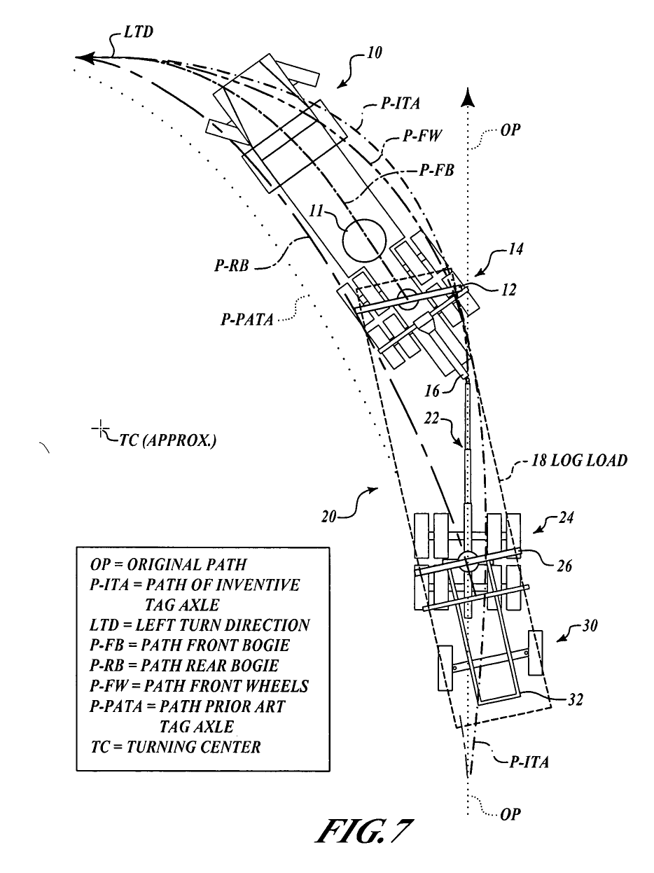

FIGS. 5A-5C are a series showing the function of the stowed tag axle support and alignment cones assemblies 38. In FIG. 5A the tag axle assembly 30 is shown resting on the rear bogie frame during the unloaded, dead-head transport as shown in FIG. 2A. As shown partly in section and partly in elevation, the tag axle frame 32 includes a number of cross braces 54a spanning the diagonal middle section 50 and 54e spanning the forward section 48 of the frame, The cross braces of rear section 52 are not shown in these views. The rear bogie frame includes main longitudinal frame members 60 to which the axles are attached (not shown in this view), and a rear cross member 62 spanning between the longitudinal frame members. Mounted pivotally on top of the cross member 62 is a plate 64 on top of which is/are mounted at least one centering cone 66 that engages a correspondingly conical receiver element 68 that is welded to the tag axle frame cross brace 54e. As seen in FIG. 2A this supports the tag axle during empty road hauling, the cones retaining and centering the tag axle so that it does not swing or slew from side to side in turns, as the tag axle is free to pivot on the cup and saucer of the rear bunk (see FIGS. 4 and 7 ).

By comparing FIGS. 5A with 5B, and 2A with 2C it can be understood that in FIG. 5B the tag axle is now on the ground, the rear bunk beams 60, 62 being now horizontal. In this position, the cones are still in the up position so that as the tag axle is set on the ground, it remains properly aligned with the rear bogie and its bunk. FIG. 5C shows the partly and fully loaded position, in which the bellows have been inflated so that the cones may be lowered by pivoting the plate 64 as shown by arrow A. Once the cones are rotated down, the tag axle freely follows the pivoting of the rear bogie bunk as it is no longer connected to or aligned with the bogie frame 60, 62. The lever 70 attached to the plate 64 is optional. Note the forward portion 69a of the receiver assembly 68 is cut away, as compared to the rear section 69b to permit the cone 66 to rotate to the down, load use position, see also FIG. 1. FIG. 5C also shows the load beam 34 raised into contact with at least some logs 18a, 18b loaded on the trailer.

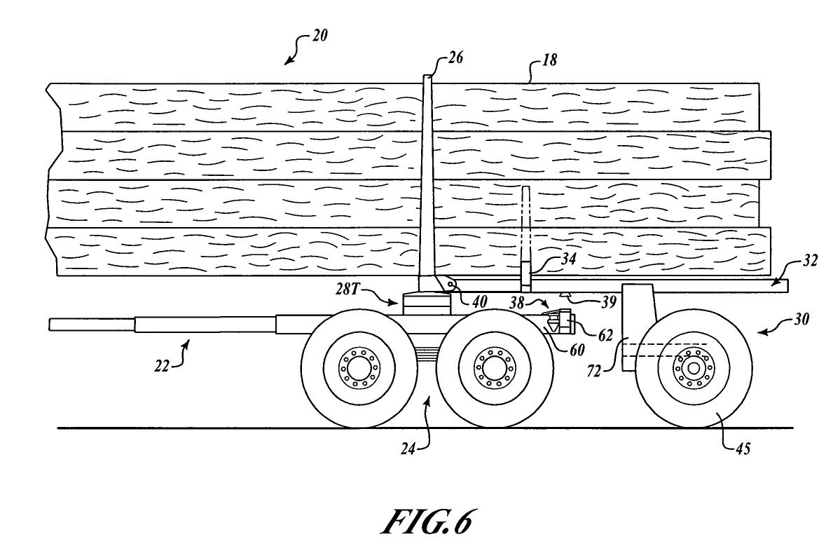

FIG. 6 shows an alternate, straight frame embodiment of the inventive tag axle assembly 30 when logs are loaded. The rear end of the log trailer 20, with its bunk 26 is supported by the cup and saucer 28T, which in turn is supported by the trailer bogie frame and axle assembly 24. The third axle assembly 30 has its air suspension assembly 36 (not shown) inflated. The rear end of the third axle assembly frame is raised so the load beam 34 contacts and supports the weight of the log load 18, the front end remaining hitched to the bunk at attachment point 40, which points are high, relative to a conventional point of attachment of a tag axle frame which is ordinarily attached to the cross member 62 of the rear bogie frame 60. The mid-point of the frame 32 includes the cone and receiver assemblies 38, 39 as described above for the Z-frame embodiment. In this FIG. 6 embodiment, the axle, suspension, lift bellows and wheels 45 are secured to a generally L-shaped frame member 72 extending down from the approximate mid-point of the rails of frame 32.

In an alternate embodiment for lifting the tag axle when the trailer is unloaded but stowage of the bogie and tag axle as in FIG. 2A is not desired (e.g., short job to job transfer), standard lift bellows can be attached to the top of the bogie frame members 60, 62 to raise the wheels and axle 45 of the tag axle. This is useful to minimize tag axle tire wear. In addition, frame 32 can be provided with lockable pivots (such as a yoke and tongue assembly) to be pivotable at a point just behind the cone/receiver assemblies 38, 39 and a pair of hydraulic rams or linear actuators fitted between the resulting forward and rear sections of the tag axle frame to pivot the tag axle from about 45 to about 135° counterclockwise up and over onto the forward frame of the tag axle or the frame of the trailer bogie just behind the bunk. This shortens the length of the inventive 3-axle trailer bogie/tag axle combination for unloaded travel, even when loaded onto the front bogie as in FIG. 2A.

FIG. 7 shows the turning characteristics of a logging truck 10 and trailer 20 with the inventive third axle assembly 30 installed making a left turn to illustrate the reduction, to the point of near elimination, of the cut-across phenomenon. This view is highly schematic and simplified as the physics is complex and a turn is a kinetic event. Without wishing to be bound by theory, and understanding the qualitative nature of the figure, a key element affecting the turning characteristics is the trailer reach 22. The rear end of the reach is permanently and non-pivotally attached to the front of the trailer bogie 24. That attachment comprises a tube, typically square but may also be round, hexagonal or octagonal, that extends from the rear end of the trailer bogie frame to forward of the bogie frame, in which at least one or more smaller tube(s) telescopingly fit(s). When log hauling is in progress, the front end of the reach is attached to the rearmost point of the stinger 16, which projects rearwardly from the tractor frame. The reach telescopes in length to accommodate the lengths of payload, and varies in length as necessary to accommodate turning of the truck and trailer rig. When the front of the truck turns left, the stinger swings right, causing the trailer bogie 24 to steer further to the right than it would without the reach. This steering action causes the turning of the trailer to start later than the truck, and can function to reduce the cut-across effect as the turning circle of the trailer is somewhat greater than it would be without the reach. The effect is to reduce the tendency of the trailer to track inside the truck in right and left turns. However, there is still a cut-across effect, as the later start of turning of the trailer does not necessarily mean that it starts the turn at the same place the truck started its turn. Indeed, even though the stinger is swinging right, that is momentary until is begins to move to the left as the truck continues the turn.

Further to the complexity, the extent of this steering effect is affected by the ratio of the distance from the stinger end to the median of the rear axles of the truck and the distance of the stinger to the median of the axles of the trailer. If these distances could be made the same, the trailer wheels would track precisely behind the rear truck wheels. This is why many gravel trucks towing trailers use very elongated booms. In practice, such a condition is rarely practicable, especially in the case of logging trucks, where the load length varies considerably. Further, the addition of a tag axle attached to the trailer frame moves the median point of the trailer axles backward, typically form between the two axles of the trailer to behind the normal rear axle. This lengthening changes the Stinger/Reach ratio, making the number even smaller. As the number gets smaller, the degree of tracking inside the truck is increased. That is, adding a tag axle attached to the trailer axle or frame tends to defeat the effect of stinger steering to reduce cut-across, causing the trailer to return to a steering cut-across track.

In FIG. 7 the various paths are identified as follows (the stinger steering effect being essentially minimized to more clearly show the cut-across effect):
OP=Original Path of truck and trailer, going generally North;
LTD=Left Turn Direction
P-FW=Path of Tractor Front Wheels
P-PATA=Path of Prior Art Tag Axles as attached to rear bogie axle or frame
P-FB=Path of Front Bogie
P-RB=Path of Rear Bogie
P-ITA=Path of Inventive Tag Axle as attached to rear bogie bunk

Note that during turns, both bunks swivel as seen in FIG. 7 so that the log payload is not in alignment with the truck, reach or trailer longitudinal axes and the bunks are not parallel to their bogie axles. Thus, by attaching the tag axle transversely rigid to the trailer bunk (no lateral movement), the tag axle is linked to the bunk and not the trailer axle or frame. As seen in FIG. 6, the tag axle, by following the bunk, more closely follows the stinger steering effect, and the inventive tag axle does not exacerbate the turn geometry. That is, the inventive tag axle tracks more nearly in the proper lane. It tends significantly less to cut across inside the tractor turn in both left and right turns, and thus is a safer rig. Indeed, it tracks closely to the path of the front wheels of the tractor.

### Industrial Applicability

It is clear that the inventive third axle assembly of this application has wide applicability to the logging industry, namely to hauling of logs by truck and trailer. The system clearly allows an increase in payload over that of a standard truck and trailer rig by adding a third axle to the trailer without compromising maneuverability Thus, the inventive third axle assembly and has the clear potential of becoming adopted as the new standard for apparatus and methods of hauling logs over the public highways.

It should be understood that various modifications within the scope of this invention can be made by one of ordinary skill in the art without departing from the spirit thereof and without undue experimentation. For example, the hinge-like attachment of the third axle assembly to the bunk can have a wide range of designs to provide the functionalities disclosed herein. Likewise the load bearing beam or the tag axle may be curved rather than straight or Z-shaped (in side elevation view). Further, the tag axle longitudinal beams may be hinged at one or more points intermediate of the forward end and the rear so that the tag axle axle/wheel/bellows assembly can be pivoted (as seen in FIGS. 1 or 4), either counterclockwise forward over the forward section of the tag axle frame, or, in the case of two or three pivots in the middle section of the frame (say at the juncture of section 50 with sections 48 and 52), the axle/wheel either simply moves forward or rotates clockwise. Alternatively, the tag axle longitudinal frame members can telescope. The result is to shorten the overhang of the tag axle as seen in FIG. 2A. This invention is therefore to be defined by the scope of the appended claims as broadly as the prior art will permit, and in view of the specification if need be, including a full range of current and future equivalents thereof.

PARTS LIST To assist examination; may be canceled
upon allowance at option of Examiner.

| | |
|---|---|
| 10 | Standard log truck |
| 11 | Crane |
| 12 | Forward Bunk |
| 13 | Grapple |
| 14 | Truck bogie (front bogie) |
| 15 | Truck Tag Axle |
| 16 | Truck stinger |
| 17 | Auxiliary Axle for Crane |
| 18 | Logs |
| 19 | Crane legs |
| 20 | Standard log trailer |
| 21 | Lift Cable |
| 22 | Trailer's reach a)middle tube b)outer sleeve c)inner tube |
| 23 | Rear Bogie Rest |
| 24 | Trailer's bogie |
| 25 | Stinger Pivot |
| 26 | Trailer's bunk a, b |
| 28F, 28T | Cup and Saucer (Forward and Trailer respectively) |
| 30 | Third Axle Assembly |
| 32 | Framework of third axle assembly |
| 34 | Load bearing beam of third axle assembly |
| 35 | Bellows |
| 36 | Steerable reverse caster air suspension assembly |
| 37 | Steering Linkage |
| 38 | Resting cones for third axle assembly unloaded |
| 39 | Receivers for cones a, b |
| 40 | Third axle assembly attachment points a, b |
| 42A, 42B | Attachment points on trailer bunk |
| 43 | Axle |
| 44A, 44B | Attachment points on third axle assembly |
| 45 | Tag Axle Wheel |
| 46 | Bolt (2) a, b |
| 47 | Bolt Hole |
| 48 | Forward frame section a, b |
| 50 | Frame offset |
| 52 | Rearward axle section of frame |
| 54 | Cross braces a, b, c, d, e |
| 60 | Rear Bogie Frame member |
| 62 | Rear Bogie Cross Bracket |
| 64 | Cone Mount Plate |
| 66 | Cone Assembly |
| 68 | Receiver |
| 69 a, b | Forward and back portions of receiver assembly |
| 70 | Optional Pivot Lever |
| 72 | L-shaped frame member |
| 74 | Pneumatic caster cylinder |
| 76 | Air brake cylinder |

Arrows:

| | |
|---|---|
| A | Path of Cone Rotation |
| OP | Original Path direction of truck |
| LTD | Left turn direction of travel |
| P-PATA | Path of Travel of Prior Art Tag Axle in a turn |
| P-FW | Path of Front Wheels |
| P-RB | Path of rear Bunk in left turn |
| P-FB | Path of Front Bunk in left turn |
| P-ITA | Path of Inventive Tag Axle in Left Turn |

1) An improved third, tag axle for a logging trailer having a rear bogie assembly, said rear bogie assembly including a frame to which at least one axle assembly and a pivoting bunk assembly are mounted, said bunk being pivotally mounted on a cup and saucer assembly, comprising in operative combination:
a. a frame assembly having parallel, spaced longitudinal frame members configured to define a forward section having a forward end and a rearward section, said longitudinal frame members being connected by a plurality of spaced transverse braces and by a transverse load bearing beam member disposed to extend beyond said longitudinal frame members with at least a portion extending above top surfaces of said longitudinal beams to permit contact with a log load;
b. a steerable reverse caster axle assembly secured to said frame rearward section, said axle assembly including a pneumatic lift bellows for selectively elevating or lowering said frame;
c. a connector member secured to the forward ends of each longitudinal frame member configured to engage corresponding mating connector members mounted on the bunk of said rear bogie, said connector members of said axle assembly and said bunk cooperating to permit hitching said axle to said bunk and to permit only vertical, up and down movement of said tag axle with respect to said bunk yet follow the pivoting of said bunk on its cup and saucer mounting assembly; and
d. said third, tag axle having superior maneuvering capability and tracking characteristics as exemplified by exhibiting a reduced cut-across tendency when following the log load loaded on said rear bunk during a turn, said hitch location permitting said third tag axle to follow a turn path independent of the path of said rear bogie.

2) A tag axle assembly as in claim 1 wherein at least one cross brace is disposed in said forward section, and said cross brace includes at least one receiver assembly mounted to an underside thereof, said receiver assembly cooperatingly receiving a centering and support assembly mounted to said frame member of said rear bogie.

3) A tag axle assembly as in claim 2 wherein said centering and support assembly of said bogie includes at least one cone assembly for engaging said tag axle receiver assembly to support said tag axle assembly when said rear bogie and tag axle are loaded on a logging truck, and to properly align said tag axle with respect to said bogie when unloaded onto the ground and up to initial stages of log loading.

4) A tag axle assembly as in claim 3 wherein said cone assembly is pivotable between a first, tag axle load-bearing position in which it engages said receiver of said tag axle, and a second, free position in which said cone is disengaged from said tag axle receiver so that said tag axle is able to move vertically up and down and to follow the pivoting of said rear bogie bunk.

5. A tag axle assembly as in claim 1 wherein said tag axle frame assembly includes a middle section between said front and rearward sections that is configured to clear the tires of said rear bogie during turns.

6) A tag axle assembly as in claim 2 wherein said connector members comprise a yoke and tongue connected through aligned holes by a pin member.

7) An improved trailer for a logging truck comprising in operative combination:
a. a trailer comprising a bogie assembly including a frame to which at least one axle assembly and a pivoting bunk assembly are mounted, said bunk being pivotally mounted on a cup and saucer assembly and including a pair of spaced hitch assemblies;
b. third, tag axle removably hitched to said bogie bunk at said bunk hitch assemblies;
c. said tag axle comprising a frame assembly having parallel, spaced longitudinal frame members configured to define a forward section having a forward end and a rearward section, said longitudinal frame members being connected by a plurality of spaced transverse braces and by a transverse load bearing beam member disposed to extend beyond said longitudinal frame members with at least a portion extending above top surfaces of said longitudinal beams to permit contact with a log load;
d. a steerable reverse caster axle assembly secured to said tag axle frame rearward section, said axle assembly including a pneumatic lift bellows for selectively elevating or lowering said tag axle frame with respect to said bogie frame;
e. a pair of connector members, one secured to the forward ends of each tag axle longitudinal frame member and configured to matingly engage said hitch members mounted on the bunk of said trailer bogie, said connector members of said axle assembly and said bunk cooperating to permit hitching said tag axle to said bunk to permit only vertical, up and down movement of said tag axle with respect to said bunk yet follow the pivoting of said bunk on its cup and saucer mounting assembly; and
f. said third, tag axle having superior maneuvering capability and tracking characteristics as exemplified by exhibiting a reduced cut-across tendency when following the log load loaded on said trailer bunk during a turn, said hitch location permitting said third tag axle to follow a turn path independent of the path of said trailer bogie.

8) A trailer assembly as in claim 7 wherein:
a. at least one cross brace is disposed in said forward section of said tag axle and said cross brace includes at least one receiver assembly mounted to an underside thereof;
and which includes:
b. a centering and support assembly mounted to said trailer bogie frame aligned with said receiver assembly; and
c. said receiver assembly cooperatingly receives said centering and support assembly mounted to said frame member of said trailer bogie.

9) A trailer assembly as in claim 8 wherein said centering and support assembly of said bogie includes at least one cone assembly for engaging said tag axle receiver assembly to support said tag axle assembly when said trailer bogie and tag axle are loaded on a logging truck, and to properly align said tag axle with respect to said bogie frame when unloaded onto the ground and up to initial stages of log loading.

10) A trailer assembly as in claim 9 wherein said trailer bogie cone assembly is pivotable between a first, tag axle load-bearing upward position in which it engages said receiver of said tag axle, and a second, free position in which said cone is disengaged from said tag axle receiver so that said tag axle is able to move vertically up and down and to follow the pivoting of said trailer bogie bunk.

11) A trailer assembly as in claim 7 wherein said tag axle frame assembly longitudinal frame members include a middle section between said front and rearward sections that is configured to clear the tires of said trailer bogie during turns.

12) A trailer assembly as in claim 11 wherein said sections of said tag axle longitudinal frame members are oriented with said forward and rearward sections relatively horizontal in use and vertically offset with said forward section higher than said rearward section, and said middle section of said longitudinal frame members is inclined at an angle to said forward and rearward sections, generally forming a Z-shape as seen in elevation.

13) A trailer assembly as in claim 10 wherein said cone assembly is mounted on a transverse plate carried on top of a bogie frame cross piece, said plate is hinged adjacent one of said plate transverse margin edges to permit said plate to be rotated from said first cone-upward orientation to said second, cone-free position in which said cones are oriented generally downward.

14) A trailer assembly as in claim 7 wherein said connector members comprise a yoke and tongue connected through aligned holes by a pin member.

15) A method of improving the tracking and maneuverability of a logging truck trailer third, tag axle having a load bearing cross-beam, wherein said trailer includes a frame to which are mounted axle and wheel assemblies forming a bogie and a bunk that is rotationally mounted on a cup and saucer assembly connected to said frame, comprising the steps of:
a. mounting said tag axle directly to said trailer bunk;
b. restraining the movement of said tag axle during use to up and down motion in a vertical plane to follow road motion without side to side sway; and
c. raising said tag axle load bearing beam into contact with a log load to bear some of the weight of said load;
d. said tag axle thereby tracking said log load via said bunk independent of said trailer bogie frame resulting in reduced cut-across effect and more nearly tracking the logging truck tractor path during turns.

16) A method as in claim 15 which includes the step of supporting said tag axle on said bogie frame during empty transport.

17) A method as in claim 16 which includes the step of maintaining alignment of said tag axle with said bogie during empty transport and unloading.

18) A method as in claim 17 wherein said step of maintaining alignment includes constraining vertical and lateral movement of said tag axle with respect to said bogie, and includes the step after unloading of removing said constraint so that said tag axle moves up and down in said vertical plane in response to road contours, and tracks the trailer bunk independent of the bogie.

19) Method as in claim 18 wherein said step of constraining vertical and lateral movement of said tag axle during transport includes lowering said tag axle onto a load bearing element that includes and maintains lateral alignment in a constrained orientation with respect to said bogie.
